(19) United States
(12) Patent Application Publication
(10) Pub. No.: US 2025/0261102 A1
(43) Pub. Date: Aug. 14, 2025

(54) COMMUNICATION CONTROL METHOD AND USER EQUIPMENT

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/196,544

(22) Filed: May 1, 2025

Related U.S. Application Data
(63) Continuation of application No. PCT/JP2023/039403, filed on Nov. 1, 2023.
(60) Provisional application No. 63/421,788, filed on Nov. 2, 2022.

(51) Int. Cl. H04W 48/18

(52) U.S. Cl. CPC H04W 48/18

(57) ABSTRACT

In an aspect, a communication control method is a communication control method in a mobile communication system. The communication control method includes broadcasting, by a base station, system information. The communication control method includes transmitting, by the base station, an RRC release message to a user equipment. The communication control method further includes executing, by the user equipment, a slice-specific cell reselection procedure by using predetermined information when first slice information included in the system information is different from second slice information included in the RRC release message and/or when first frequency information included in the system information is different from second frequency information included in the RRC release message.

### RELATED APPLICATIONS

The present application is a continuation based on PCT Application No. PCT/JP2023/039403, filed on Nov. 1, 2023, which claims the benefit of U.S. Provisional Patent Application No. 63/421,788 filed on Nov. 2, 2022. The content of which is incorporated by reference herein in their entirety.

### TECHNICAL FIELD

The present disclosure relates to a communication control method in a mobile communication system.

### BACKGROUND

Specifications of The Third Generation Partnership Project (3GPP) that is a standardization project for mobile communication systems define Network Slicing. The network slicing is a technique of logically dividing a physical network constructed by a telecommunications carrier to configure network slices that are virtual networks.

A user equipment in a Radio Resource Control (RRC) idle state or an RRC inactive state can perform a cell reselection procedure. The 3GPP has studied slice-specific cell reselection (slice aware cell reselection or slice based cell reselection) that is a network slice-dependent cell reselection procedure (see, for example, Non-Patent Document 1). By performing the slice-specific cell reselection procedure, the user equipment can camp on, for example, a neighboring cell that supports an intended network slice.

### CITATION LIST

### Non-Patent Literature

Non-Patent Document 1: 3GPP TS 38.300 V17.2.0 (2022-9)

### SUMMARY

In an aspect, a communication control method includes receiving, by a user equipment, an RRC release message from a network, receiving, by the user equipment from the network, system information used for a slice-specific cell reselection procedure, and executing, by the user equipment, the slice-specific cell reselection procedure by using only the RRC release message when the RRC release message includes information indicating a correspondence relationship between a slice group and a frequency.

In an aspect, a communication control method is a communication control method in a mobile communication system. The communication control method includes reporting, by a network apparatus, system information. The communication control method includes transmitting, by the network apparatus, an RRC release message to a user equipment. The communication control method further includes executing, by the user equipment, a slice-specific cell reselection procedure by using predetermined information when first slice information included in the system information is different from second slice information included in the RRC release message and/or when first frequency information included in the system information is different from second frequency information included in the RRC release message.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a User Equipment (UE) according to the first embodiment.

FIG. 3 is a diagram illustrating a configuration example of a gNB (base station) according to the first embodiment.

FIG. 4 is a diagram illustrating a configuration example of a protocol stack of a user plane according to the first embodiment.

FIG. 5 is a diagram illustrating a configuration example of a protocol stack of a control plane according to the first embodiment.

FIG. 6 is a diagram for explaining an overview of a cell reselection procedure.

FIG. 7 is a diagram illustrating a schematic flowchart of a typical cell reselection procedure.

FIG. 8 is a diagram illustrating an example of network slicing.

FIG. 9 is a diagram illustrating an overview of a slice-specific cell reselection procedure.

FIG. 10 is a diagram illustrating an example of slice frequency information.

FIG. 11 is a diagram illustrating a basic flowchart of the slice-specific cell reselection procedure.

FIGS. 12A and 12B are diagrams illustrating a configuration example of an SIB 16 according to the first embodiment.

FIGS. 13A and 13B are diagrams illustrating a configuration example of an RRC release message according to the first embodiment.

FIG. 14 is a diagram illustrating an operation example according to the first embodiment.

FIG. 15 is a diagram illustrating an operation example according to a second embodiment.

FIG. 16 is a diagram illustrating another operation example according to a third embodiment.

FIG. 17 is a diagram illustrating an operation example according to a fourth embodiment.

FIG. 18 is a diagram illustrating an operation example according to a fifth embodiment.

### DESCRIPTION OF EMBODIMENTS

A mobile communication system according to an embodiment is described with reference to the drawings. In the description of the drawings, the same or similar parts are denoted by the same or similar reference signs.

### First Embodiment

### Configuration of Mobile Communication System

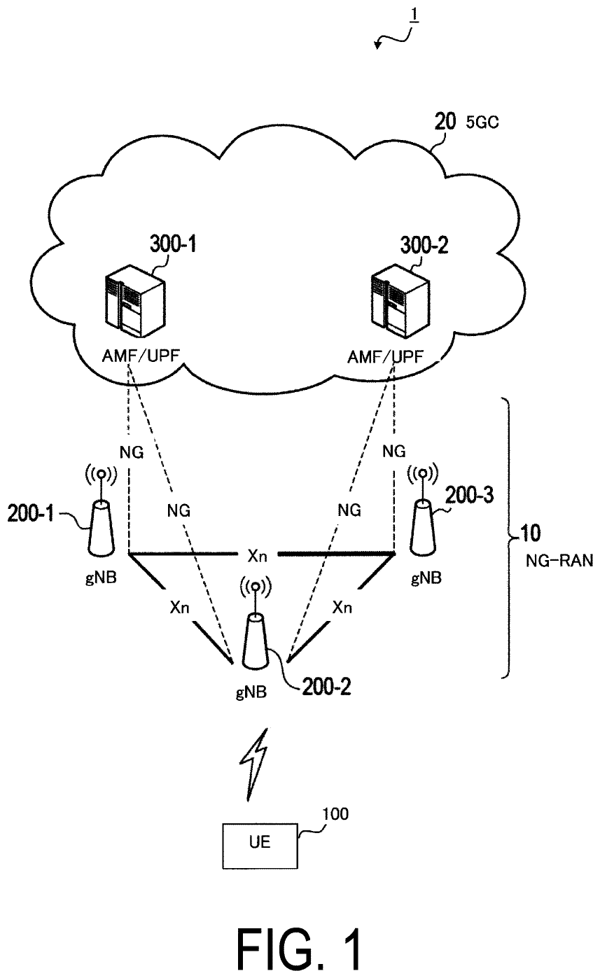

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB 200 can also be connected to an Evolved Packet Core (EPC) that is an LTE core network. An LTE base station can be also connected to the 5GC 20. The LTE base station and the gNB 200 can also be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

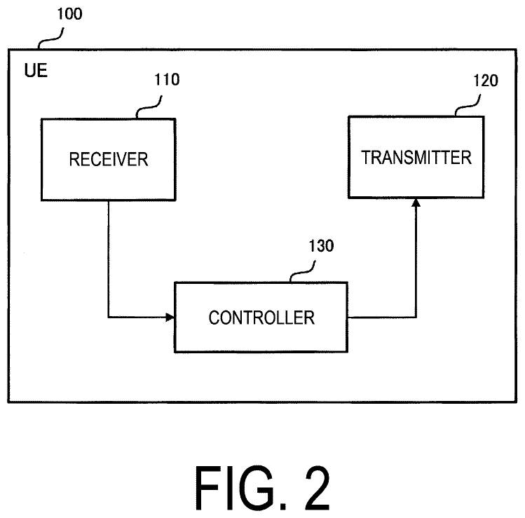

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform all processing or each operation in the UE 100 in each embodiment to be described below.

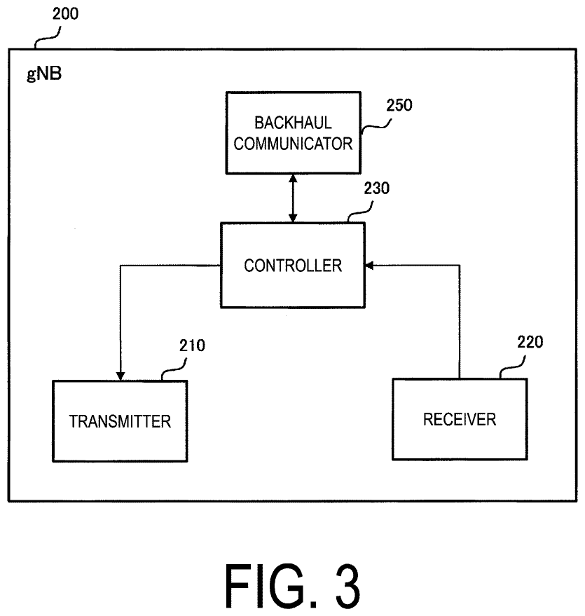

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The controller 230 may perform all of the processing and operations in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

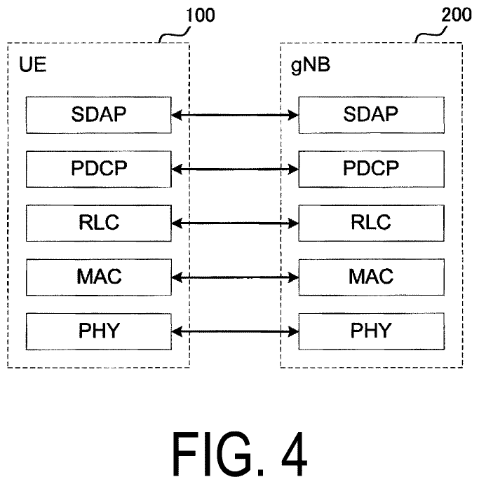

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with Cyclic Redundancy Code (CRC) parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

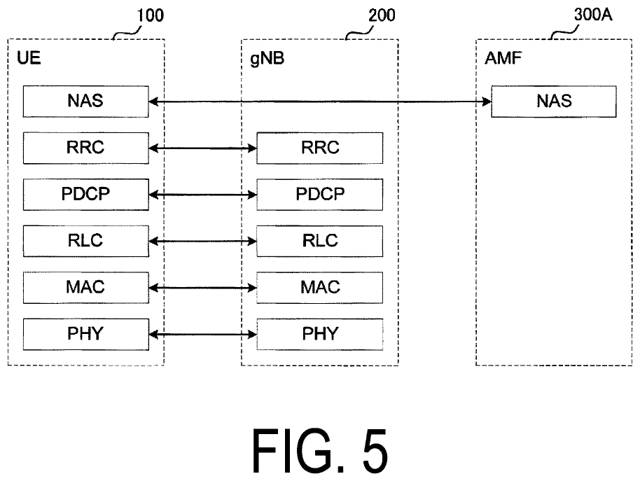

FIG. 5 is a diagram illustrating a configuration of a protocol stack of a radio interface of a control plane handling signaling (control signal).

The protocol stack of the radio interface of the control plane includes a Radio Resource

Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as Access Stratum (AS).

### Overview of Cell Reselection Procedure

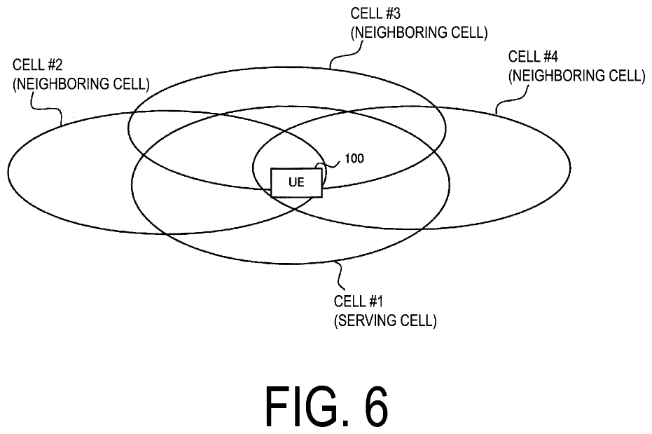

FIG. 6 is a diagram for explaining an overview of a cell reselection procedure.

The UE 100 in the RRC idle state or the RRC inactive state performs the cell reselection procedure to migrate from a current serving cell (cell #1) to a neighboring cell (any one of cells #2 to #4) as the UE 100 migrates. More specifically, the UE 100 specifies a neighboring cell on which the UE needs to camp by the cell reselection procedure, and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200. The current serving cell and the neighboring cell may be managed by the gNBs 200 different from each other.

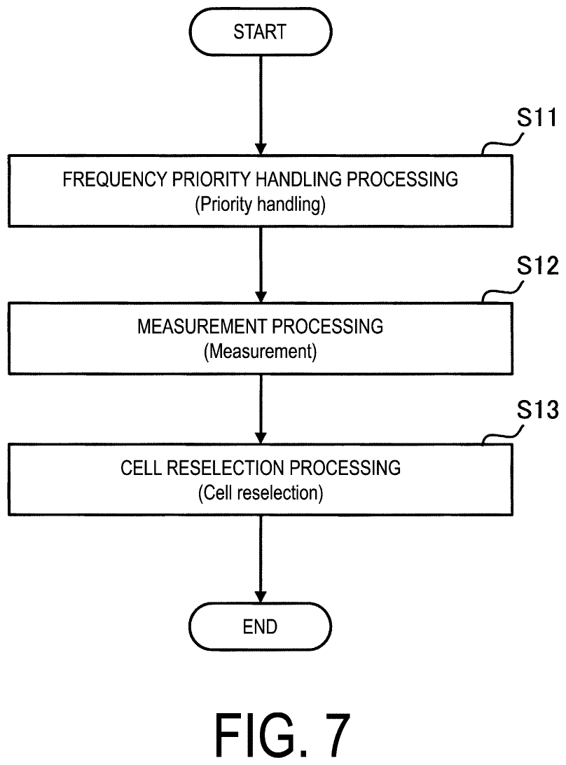

FIG. 7 is a diagram illustrating a schematic flowchart of a typical (or legacy) cell reselection procedure.

In step S11, the UE 100 performs frequency prioritization processing based on a priority per frequency (also referred to as an “absolute priority”) specified by the gNB 200 by way of, for example, an RRC release message. More specifically, the UE 100 manages the frequency priority designated by the gNB 200 per frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, more specifically, a Cell Defining-Synchronization Signal and PBCH block (CD-SSB). For example, the UE 100 measures the radio quality of the frequencies having higher priorities than a priority of the frequency of the current serving cell at all times, and, as for frequencies having priorities equal to or lower than the priority of the frequency of the current serving cell, measures the radio quality of the frequencies having priorities equal to or lower than the priority of the frequency of the current serving cell when the radio quality of the current serving cell goes below a predetermined quality.

In step S13, the UE 100 performs cell reselection processing of reselecting a cell on which the UE 100 is to camp based on the measurement result in step S12. For example, when the priority of a frequency of a neighboring cell is higher than the priority of the current serving cell and the neighboring cell satisfies a predetermined quality standard (i.e., minimal required quality standard) for a predetermined period of time, the UE 100 may perform cell reselection for the neighboring cell. When the priorities of the frequencies of the neighboring cells are the same as the priority of the current serving cell, the UE 100 may rank the radio qualities of the neighboring cells, and perform cell reselection for the neighboring cells ranked higher than the ranking of the current serving cell for a predetermined period of time. When the priorities of the frequencies of the neighboring cells are lower than the priority of the current serving cell, the radio quality of the current serving cell is lower than a certain threshold, and the radio qualities of the neighboring cells are continuously higher than another threshold for the predetermined period of time, the UE 100 may perform cell reselection for the neighboring cell.

### Overview of Network Slicing

Network slicing is a technique of creating a plurality of virtual networks by virtually dividing a physical network (e.g., a network including the NG-RAN 10 and the 5GC 20) constructed by a telecommunications carrier. Each virtual network is referred to as a “network slice”. Hereinafter, a network slice will be also referred to simply as a “slice”.

The network slicing allows a telecommunications carrier to create slices conforming to service requirements of different service types, such as enhanced Mobile Broadband (eMBB), Ultra-Reliable and Low Latency Communications (URLLC), and massive Machine Type Communications (mMTC), for example, to optimize network resources.

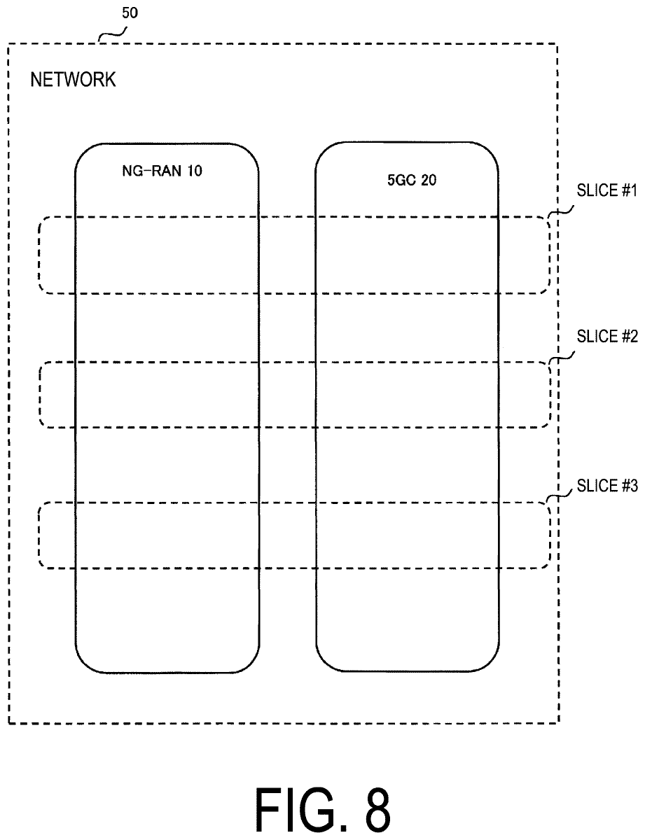

FIG. 8 is a diagram illustrating an example of network slicing.

Three slices (slices #1 to #3) are configured on a network 50 including the NG-RAN 10 and the 5GC 20. The slice #1 is associated with the service type called eMBB, the slice #2 is associated with the service type called URLLC, and the slice #3 is associated with the service type called mMTC. Note that three or more slices may be configured on the network 50. One service type may be associated with a plurality slices.

Each slice is provided with a slice identifier for identifying the slice. Examples of the slice identifier include Single Network Slicing Selection Assistance Information (S-NSSAI). The S-NSSAI includes an 8-bit Slice/Service Type (SST). The S-NSSAI may further include a 24-bit Slice Differentiator (SD). The SST is information indicating a service type with which a slice is associated. The SD is information for differentiating a plurality of slices associated with the same service type. Information including a plurality of pieces of S-NSSAI is referred to as Network Slice Selection Assistance Information (NSSAI).

One or more slices may be grouped to configure a slice group. A slice group is a group including one or more slices, and a slice group identifier is assigned to the slice group. The slice group may be configured by the core network (e.g., AMF 300), or may be configured by the radio access network (e.g., gNB 200). The UE 100 may be notified of the configured slice group.

Hereinafter, the term “network slice (slice)” may refer to S-NSSAI that is an identifier of a single slice or NSSAI that is a collection of pieces of S-NSSAI. The term “network slice (slice)” may refer to a slice group that is a group of one or more pieces of S-NSSAI or NSSAI. The slice group may be represented by NSSAI. The slice group may be represented by a Network Slice Access Stratum Group (NSAG).

The UE 100 determines a desired slice that the UE 100 desires to use. The desired slice may be referred to as an “Intended slice”. In the first embodiment, the UE 100 determines a slice priority per network slice (desired slice). For example, the NAS of the UE 100 determines the slice priority based on an operation status of an application in the UE 100, a user operation/configuration, and/or the like, and notifies the AS of slice priority information indicating the determined slice priority. Note that the NAS of the UE 100 receives the slice priority information from the AMF 300. That is, the AMF 300 determines the slice priority per slice. The AMF 300 transmits the slice priority information indicating the slice priority to the NAS of the UE 100. The NAS of the UE 100 may determine the slice priority based on the slice priority information received from the AMF 300.

### Overview of Slice Specific Cell Reselection Procedure

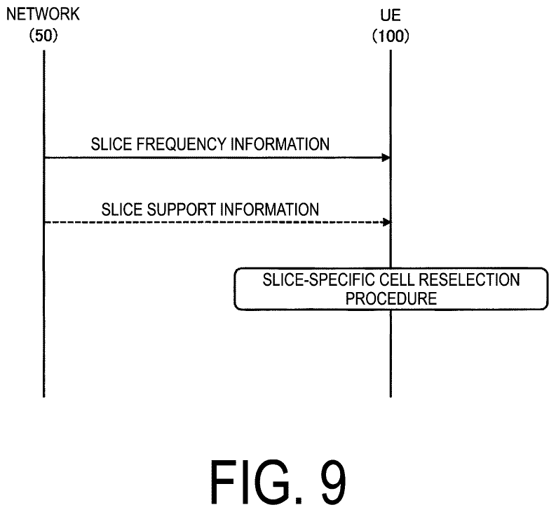

FIG. 9 is a diagram illustrating an overview of a slice-specific cell reselection (slice aware cell reselection or slice based cell reselection) procedure.

In the slice-specific cell reselection procedure, the UE 100 performs cell reselection processing based on slice frequency information provided from the network 50. The slice frequency information may be provided from the gNB 200 to the UE 100 through dedicated signaling (e.g., RRC release message).

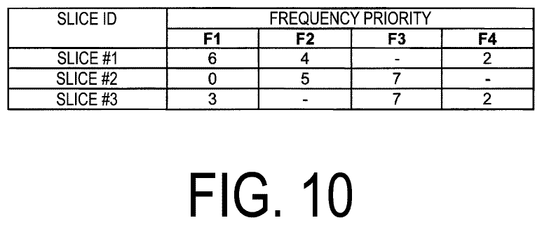

The slice frequency information is information indicating mapping between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example in FIG. 10, although the priority is assumed to be higher as a numeral of a frequency priority becomes greater, the priority may be higher as a numeral of a frequency priority becomes smaller.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

The three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from an absolute priority in a cell reselection procedure of related art.

As illustrated in FIG. 9, the UE 100 may perform cell reselection processing based on slice support information provided from the network 50. The slice support information may be information indicating mapping between cells (e.g., a serving cell and each neighboring cell) and network slices that are not provided or provided by the cells. For example, a cell may not temporarily provide some or all network slices for a reason of congestion or the like. That is, even for a slice support frequency capable of providing a network slice, some cells in the frequency may not provide the network slice. Based on the slice support information, the UE 100 can recognize a network slice not provided by each cell. Such slice support information may be provided from the gNB 200 to the UE 100 through broadcast signaling (e.g., system information block) or dedicated signaling (e.g., RRC release message).

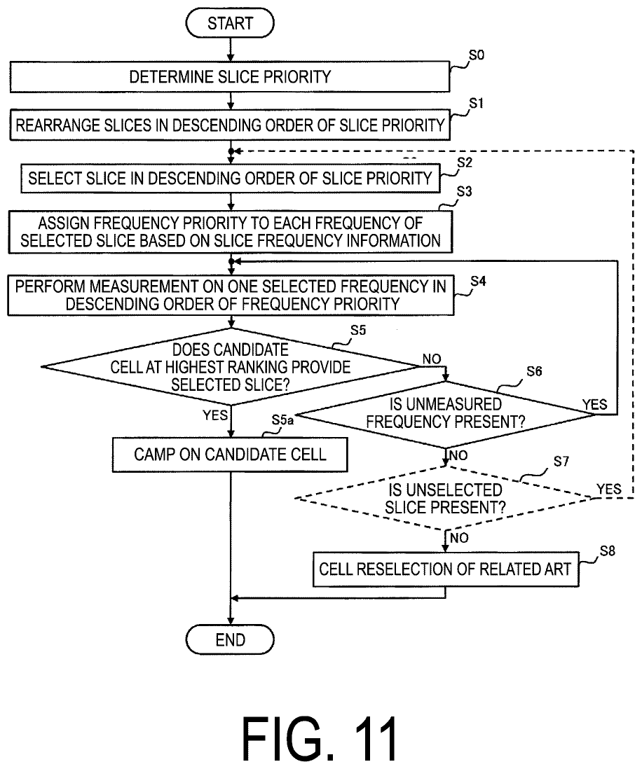

FIG. 11 is a diagram illustrating a basic flowchart of the slice-specific cell reselection procedure. It is assumed that, before starting the slice-specific cell reselection procedure, the UE 100 is in the RRC idle state or the RRC inactive state, and receives and retains the above-described slice frequency information. Note that a procedure of the “slice-specific cell reselection” indicates the “slice-specific cell reselection procedure”. In this regard, in the following, “slice-specific cell reselection” and “slice-specific cell reselection procedure” may be used in the same sense.

In step S0, the NAS of the UE 100 determines the slice identifiers of desired slices for the UE 100 and the slice priorities of the respective desired slices, and notifies the AS of the UE 100 of slice priority information including the determined slice priorities. The “desired slices” are “Intended slices”, and include a slice that is likely to be used, a candidate slice, a desired slice, a slice with which communication is desired, a requested slice, an allowed slice, or a planned slice. For example, the slice priority of the slice #1 is determined to be “3”, the slice priority of the slice #2 is determined to be “2”, and the slice priority of the slice #3 is determined to be “1”. Although the priority is assumed to be higher as a numeral of a slice priority becomes greater, the priority may be higher as a numeral of a slice priority becomes smaller.

In step S1, the AS of the UE 100 rearranges the slices (slice identifiers) notified by the NAS in step S0, in descending order of slice priority. A list of the slices arranged in this manner will be referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each frequency associated with the selected network slice. More specifically, the AS of the UE 100 specifies frequencies associated with the slice and assigns frequency priorities to the specified frequencies based on the slice frequency information. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 based on the slice frequency information (e.g., information in FIG. 10). The AS of the UE 100 refers to a list of the frequencies arranged in descending order of frequency priority as a “frequency list”.

In step S4, the AS of the UE 100 selects, in descending order of frequency priority, one of the frequencies of the selected network slice selected in step S2, and performs measurement processing on the selected frequency. The frequency selected in this manner is referred to as a “selected frequency”. The AS of the UE 100 may rank cells measured within the selected frequency in descending order of radio quality. Among the cells measured within the selected frequency, a cell satisfying a predetermined quality standard (i.e., minimal required quality standard) will be referred to as a “candidate cell”.

In step S5, the AS of the UE 100 specifies a cell at the highest rank based on results of the measurement processing in step S4, and determines whether the cell provides the selected network slice based on the slice support information. When determining that the cell at the highest rank provides the selected network slice (step S5: YES), the AS of the UE 100 reselects the cell at the highest rank and camps on that cell in step S5a.

On the other hand, when determining that the cell at the highest rank does not provide the selected network slice (step S5: NO), the AS of UE 100 determines in step S6 whether a frequency that is not yet measured is present on the frequency list created in step S3. In other words, the AS of the UE 100 determines whether a frequency assigned in step S3 other than the selected frequency is present in the selected network slice. When determining that a frequency that is not yet measured is present (step S6: YES), the AS of the UE 100 resumes the processing for the frequency ranked at the next highest frequency priority, and performs the measurement processing using that frequency as a selected frequency (returns to the processing of step S4).

When determining that a frequency that is not yet measured is not present on the frequency list created in step S3 (step S6: NO), the AS of the UE 100 may determine in step S7 whether an unselected slice is present on the slice list created in step S1. In other words, the AS of the UE 100 may determine whether a network slice other than the selected network slice is present on the slice list. When determining that an unselected slice is present (step S7: YES), the AS of the UE 100 resumes the processing for the network slice ranked at the next highest slice priority, and selects that network slice as a selected network slice (returns to the processing of step S2). Note that, in the basic flowchart indicated in FIG. 11, the processing in step S7 may be omitted.

When determining that an unselected slice is not present (step S7: NO), the AS of the UE 100 performs cell reselection processing of related art in step S8. The cell reselection processing of related art may mean an entirety of the typical (or legacy) cell reselection procedure illustrated in FIG. 7. The cell reselection processing of related art may also mean only cell reselection processing (step S13) illustrated in FIG. 7. In the latter case, the UE 100 may use the measurement result in step S4 without measuring the radio qualities of the cells again.

### Configuration Examples of SIB16 and RRC Release Message

A configuration example of the SIB16 and a configuration example of the RRC release message will be described.

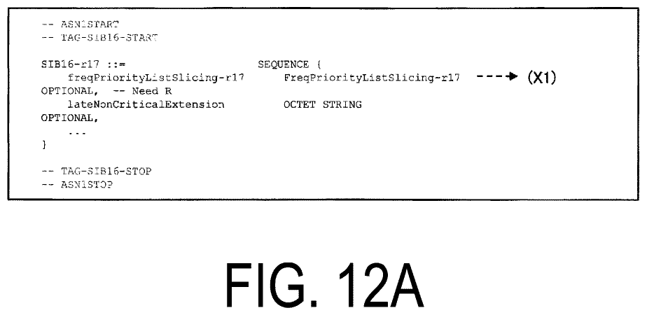

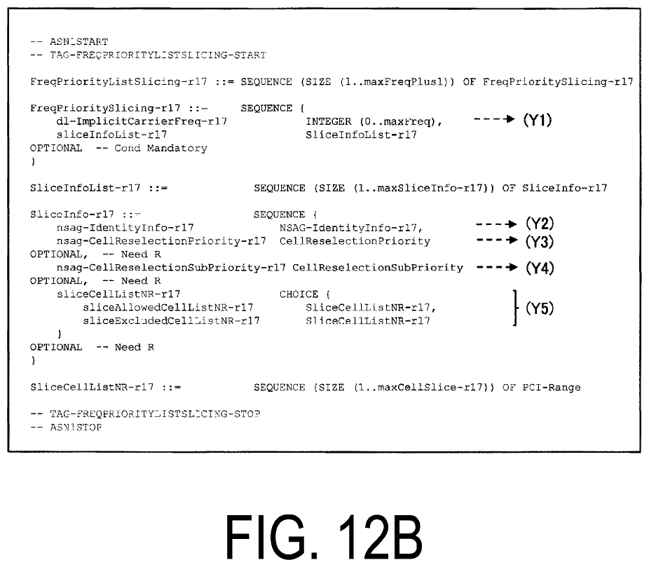

FIG. 12A is a diagram illustrating the configuration example of SIB16. FIG. 12B is a diagram illustrating a configuration example of “FreqPriorityListSlicing” (X1) that is an information element included in SIB16.

As illustrated in (Y1) of FIG. 12B, SIB16 includes frequency information (“dl-ImplicitCarrierFreq”). The frequency information indicates, for example, a frequency supported in the cell. The frequency information may include a serving frequency. Alternatively, the frequency information may include frequencies defined in the SIB4.

As illustrated in (Y2), the SIB16 includes slice group identification information (“nsag-IdentityInfo”) identifying a slice group. The slice group identification information may be the slice group identifier described above. Information (or NSAG information) itself of a network slice included in the NSAG (or slice group) is transmitted from the AMF 300 to the

UE 100 by using a NAS message. The slice group identification information represents identification information of a slice group included in the NSAG information.

As illustrated in (Y3) and (Y4), the SIB16 includes slice-frequency information (“nsag-CellReselectionPriority” and “nsag-CellReselectionSubPriority”) for each network slice included in the slice group. This information is hereinafter referred to as “slice group frequency information”. The slice group frequency information is information indicating correspondence relationships between network slices, frequencies, and frequency priorities; the number of the correspondence relationships is equal to the number of the network slices included in the slice group.

Hereinafter, “slice group information” refers to information including the “slice group identification information” (Y2) and the “slice group frequency information” (Y3 and Y4).

As illustrated in (Y5), SIB16 includes slice support information (“sliceAllowedCellList” and “sliceExcludedCellList”). The slice support information may be information indicating correspondence relationships between network slices provided by the cells and network slices not provided by the cells.

Thus, the SIB16 includes the frequency information (Y1), the slice group information (Y2, Y3, and Y4), and the slice support information (Y5). The slice group information (Y2, Y3, and Y4) includes slice group identification information (Y2) and slice group frequency information (Y3 and Y4). Note that “slice information” (SliceInfo) may collectively refer to the slice group information (Y2, Y3, and Y4) and the slice support information (Y5) included in the SIB16.

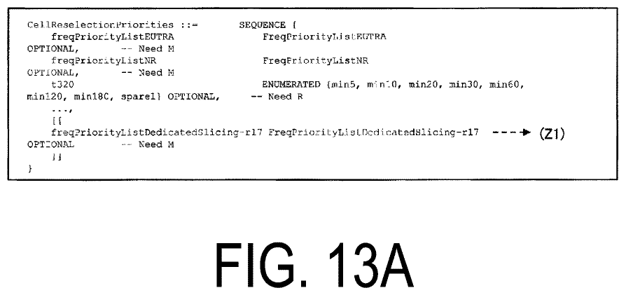

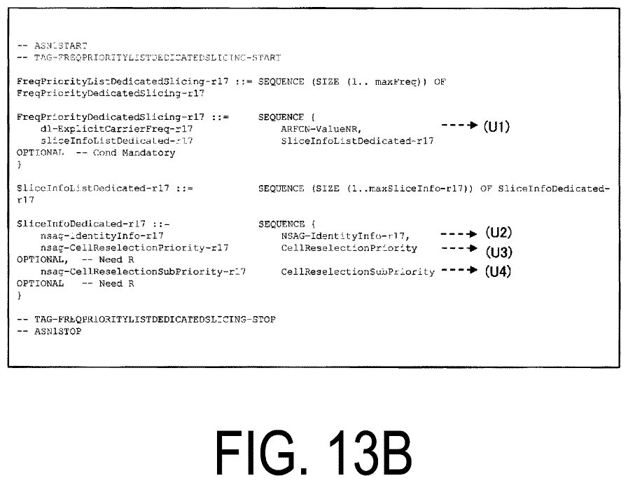

On the other hand, FIG. 13A is a diagram illustrating a configuration example of the RRC release message. FIG. 13B is a diagram illustrating a configuration example of an information element (“FreqPriorityListDedicatedSlicing”) (Z1) included in the RRC release message.

As indicated at (U1) of FIG. 13B, the RRC release message also includes the frequency information (“dl-ExplicitCarrierFreq”). The frequency information is the same as the frequency information included in the SIB16.

As indicated at (U2), the RRC release message also includes slice group identification information (“nsag-IdentityInfo”) identifying a slice group.

As indicated at (U3) and (U4), the RRC release message also includes slice group frequency information (“nsag-CellReselectionPriority” and “nsag-CellReselectionSubPriority”). However, the RRC release message includes no slice support information.

As described above, the RRC release message also includes the frequency information (U1) and the slice group information (U2, U3, and U4). The slice group information includes slice group identification information (U2) and slice group frequency information (U3 and U4). The slice group information (U2, U3, and U4) included in the RRC release message may be referred to as “dedicated slice information” (SliceInfoDedicated).

### Communication Control Method According to First Embodiment

A communication control method according to the first embodiment is described.

Currently, the 3GPP is discussing the relationship between the SIB16 and the RRC release message. Specifically, the following discussion is made.

(Proposal 1) Even when the RRC release message includes slice information (dedicated slice information), the UE 100 does not execute the slice-specific cell reselection procedure when the SIB16 is not broadcast.

(Proposal 2) When a frequency is present in the information element (“FreqPriorityListDedicatedSlicing”) of the received RRC release message and no frequency is present in the information element (“FreqPriorityListSlicing”) of the SIB16, the UE disables the NSAG (or slice group) associated with the frequency in the RRC release message.

(Proposal 3) For an NSAG that is present in the RRC release message but not in the SIB16, the UE 100 considers that such an NSAG is supported on no frequencies.

Note that these proposals are currently postponed.

As described above, the SIB16 and the RRC release message include the same information. The same information is slice group information (Y2 to Y4 and U2 to U4) and frequency information (Y1 and U1). The UE 100 can perform the slice-specific cell reselection procedure by using the slice group information and the frequency information.

However, when the slice group information included in the SIB16 is different from the slice group information included in the RRC release message, the UE 100 may not know how to execute the slice-specific cell reselection procedure. For example, when, in the same network slice, the frequency priority in the slice group information included in the SIB16 is different from the frequency priority in the slice group information included in the RRC release message, the UE 100 does not know how to determine the frequency priority to execute the slice-specific cell reselection procedure.

Similarly, when the frequency information included in the SIB16 is different from the frequency information included in the RRC release message, the UE 100 may not know which of the frequency information included in the SIB16 and the frequency information included in the RRC release message is to be used to execute the slice-specific cell reselection procedure.

An object of the first embodiment is to enable the UE 100 to appropriately execute the slice-specific cell reselection procedure even when the frequency information included in the SIB16 is different from the frequency information included in the RRC release message.

For this reason, in the first embodiment, first, the base station (for example, the gNB 200) broadcasts system information (for example, the SIB16). Second, the base station transmits the RRC release message to the user equipment (e.g., the UE 100). Third, when the first slice information included in the system information is different from the second slice information included in the RRC release message and/or when the first frequency information included in the system information is different from the second frequency information included in the RRC release message, the user equipment executes the slice-specific cell reselection procedure by using predetermined information. In the first embodiment, the predetermined information is the second slice information and/or the second frequency information.

As described above, in the first embodiment, when the information included in the SIB16 is different from the information included in the RRC release message, the UE 100 executes the slice-specific cell reselection procedure by using the information included in the RRC release message. Consequently, the UE 100 can appropriately execute the slice-specific cell reselection procedure.

### Operation Example According to First Embodiment

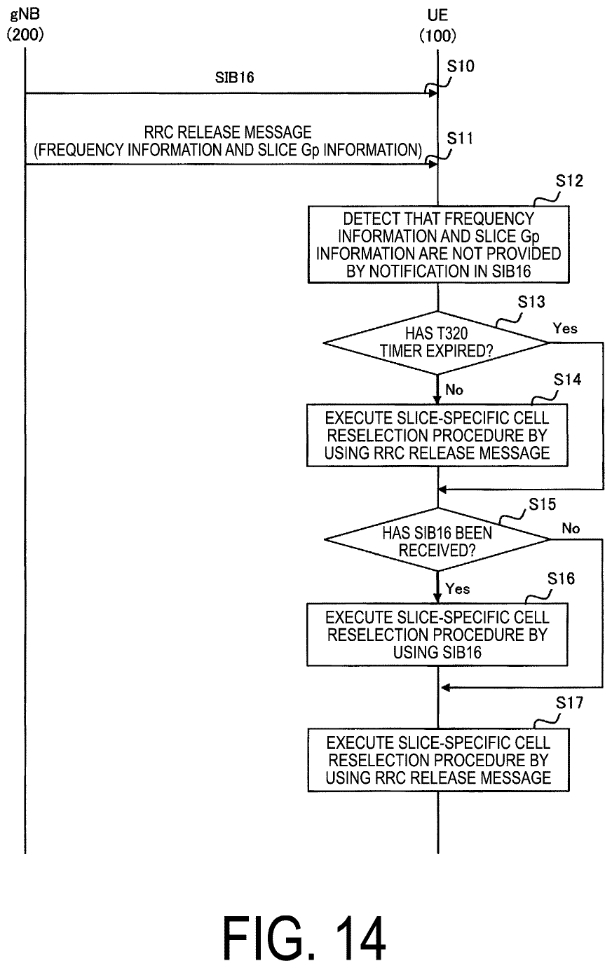

FIG. 14 is a flowchart illustrating an operation example according to the first embodiment.

As illustrated in FIG. 14, in step S10, the gNB 200 broadcasts the SIB16. However, in the first embodiment, the SIB16 is assumed to include no frequency information or slice group information. The UE 100 receives the SIB16.

In step S11, the gNB 200 transmits the RRC release message to the UE 100. However, in the first embodiment, the RRC release message is assumed to include the frequency information and the slice group information. The UE 100 receives the SIB16 including no frequency information or slice group information and the RRC release message including the frequency information and the slice group information. Note that when the UE 100 receives the RRC release message, the T320 timer included in the RRC release message starts counting. Subsequently, the UE 100 transitions to the RRC idle state or the RRC inactive state. The UE 100 in the RRC idle state or the RRC inactive state performs the subsequent processing.

In step S12, the UE 100 detects that no frequency information or slice group information is notified in the SIB16.

In step S13, the UE 100 determines whether the count value in the timer T320 has reached an expiry value (that is, whether the timer T320 has expired).

When the T320 timer has not expired (No in step S13), in step S14, the UE 100 executes the slice-specific cell reselection procedure by using the frequency information and slice group information included in the RRC release message. The UE 100 utilizes the slice group information included in the RRC release message by using the fact that network slices are uniformly supported in the same tracking area (TA) according to the Homogeneous rule.

When the T320 expires (YES in step S13), the processing transitions to step S15. That is, until the T320 timer expires, the frequency information and slice group information included in the RRC release message are subject to the slice-specific cell reselection procedure (step S14).

In step S15, the UE 100 determines whether the UE 100 has received the SIB16 including the frequency information and the slice group information group information.

Upon receiving the SIB16 (Yes in step S15), in step S16, the UE 100 executes the slice-specific cell reselection procedure by using the frequency information and slice group information included in the SIB16.

On the other hand, in step S15, when not receiving the SIB16 (No in step S15), in step S17, the UE 100 executes the slice-specific cell reselection procedure using the frequency information and slice group information included in the RRC release message (step S11). Even when the T320 expires (Yes in step S13), the UE 100 may execute the slice-specific cell reselection procedure by using the frequency information and slice group information included in the RRC release message until the SIB16 is received.

Note that, in step S17, the UE 100 may not need to support the slice-specific cell reselection procedure because the SIB16 has not been received.

The gNB 200 may indicate the number of timeouts. When the T320 timer times out, the upper limit number of times that the counting of the T320 timer is restarted may be the number of timeouts. The gNB 200 may configure the number of timeouts for the UE 100 using the RRC release message. The gNB 200 may indicate a new timer other than the T320 timer. The new timer may also be indicated by the RRC release message.

### Another Operation Example According to First Embodiment

Although, in the first embodiment, an example has been described in which the SIB16 includes no frequency information or slice group information and the RRC release message includes the frequency information and the slice group information, the present invention is not limited to this.

First, in a certain case, although both the SIB16 and the RRC release message include the frequency information, the frequency information included in the SIB16 (for example, the first frequency information) is different from the frequency information included in the RRC release message (for example, the second frequency information). Even in such a case, similarly to the first embodiment, the UE 100 may execute the slice-specific cell reselection procedure by using the frequency information included in the RRC release message (step S14 and step S17).

Second, in a certain case, although both the SIB16 and the RRC release message includes the slice group information, the slice group information included in the SIB16 (for example, the first slice group information) is different from the slice group information included in the RRC release message (for example, the second slice group information). Even in such a case, similarly to the first embodiment, the UE 100 may perform the slice-specific cell reselection procedure by using the slice group information included in the RRC release message (step S14 and step S17).

That is, when the slice group information included in the SIB16 is different from the slice group information included in the RRC release message and/or when the frequency information included in the SIB16 is different from the frequency information included in the RRC release message, the UE 100 executes the slice-specific cell reselection procedure by using the information included in the RRC release message (the frequency information and/or slice group information included in the RRC release message).

Note that the slice support information may comply with the SIB16. The slice support information may be supported by all cells according to the Homogeneous principle.

### Second Embodiment

A second embodiment will be described. In the second embodiment, differences from the first embodiment will mainly be described.

The second embodiment is an example in which the slice-specific cell reselection procedure is executed by using the information included in the SIB16 when the information included in the SIB16 is different from the information included in the RRC release message.

To be more specific, first, the base station (for example, the gNB 200) broadcasts the system information (for example, the SIB16). Second, the base station transmits the RRC release message to the user equipment (e.g., the UE 100). Third, when the first slice information included in the system information is different from the second slice information included in the RRC release message and/or when the first frequency information included in the system information is different from the second frequency information included in the RRC release message, the user equipment executes the slice-specific cell reselection procedure by using predetermined information. In the second embodiment, the predetermined information is the first slice information and/or the first frequency information.

As described above, in the second embodiment, when the information included in the SIB16 is different from the information included in the RRC release message, the UE 100 executes the slice-specific cell reselection procedure by using the information included in the SIB16. Thus, the UE 100 can appropriately perform the cell reselection procedure.

### Operation Example According to Second Embodiment

An operation example according to the second embodiment will be described.

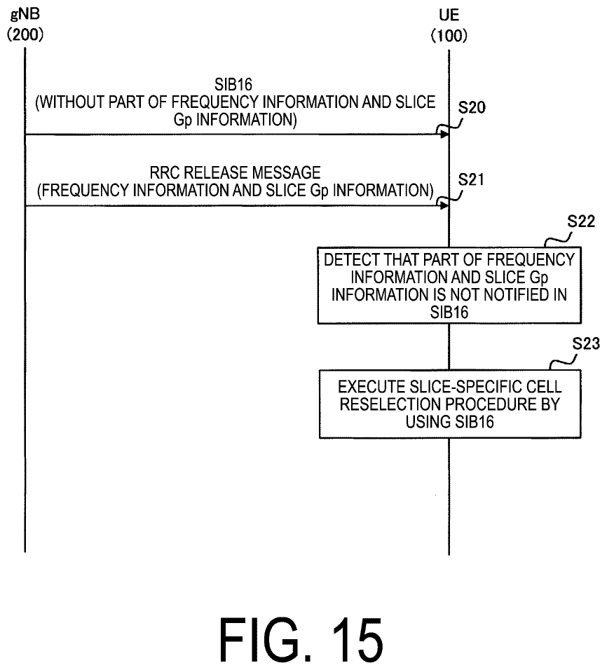

FIG. 15 is a diagram illustrating an operation example according to the second embodiment.

As illustrated in FIG. 15, the gNB 200 broadcasts the SIB16 in step S20. The SIB16 includes the frequency information and the slice group information. The UE 100 receives the SIB16.

In step S21, the gNB 200 transmits the RRC release message to the UE 100. The RRC release message includes the frequency information and the slice group information. However, in the second embodiment, the SIB16 does not include a part of the frequency information and slice group information included in the RRC release message. After receiving the RRC release message, the UE 100 transitions to the RRC idle state or the RRC inactive state.

In step S22, the UE 100 detects that the SIB16 does not include a part of the frequency information and slice group included in the RRC release message.

In step S23, the UE 100 executes the slice-specific cell reselection procedure by using the frequency information and slice group information included in the SIB16 (while ignoring the frequency information and slice group information included in the RRC release message).

Note that the UE 100 may not need to support the slice-specific cell reselection procedure when the SIB16 is not received in step S20 (or when receiving the SIB16 including no frequency information or slice group information).

### Another Operation Example According to Second Embodiment

In the second embodiment, an example has been described in which the SIB16 does not include a part of the frequency information and slice group included in the RRC release message, but the present invention is not limited to this.

First, in addition to the case where the SIB16 does not include a part of the frequency information included in the RRC release message, a case where the frequency information included in the SIB16 (for example, the first frequency information) is different from the frequency information included in the RRC release message (for example, the second frequency information) is present. Even in such a case, similarly to the second embodiment, the UE 100 may execute the slice-specific cell reselection procedure by using the frequency information included in the SIB16 (step S23).

Second, in addition to the case where the SIB16 does not include a part of the slice group information included in the RRC release message, a case where the slice group information included in the SIB16 (for example, the first slice group information) is different from the slice group information included in the RRC release message (for example, the second slice group information) is present. Even in such a case, similarly to the second embodiment, the UE 100 may perform the slice-specific cell reselection procedure by using the slice group information included in the SIB16 (step S23).

Note that the slice support information may comply with the SIB16. The slice support information may be supported by all cells according to the Homogeneous principle.

### Third Embodiment

A third embodiment will be described. Also in the third embodiment, differences from the first embodiment will mainly be described.

In the third embodiment, an example will be described in which, when the information included in the SIB16 is different from the information included in the RRC release message, an AND condition is applied to both pieces of information, and the slice-specific cell reselection procedure is executed by using information common to both pieces of information.

To be more specific, first, the base station (for example, the gNB 200) broadcasts the system information (for example, the SIB16). Second, the base station transmits the RRC release message to the user equipment (e.g., the UE 100). Third, when the first slice information included in the system information is different from the second slice information included in the RRC release message and/or when the first frequency information included in the system information is different from the second frequency information included in the RRC release message, the user equipment executes the slice-specific cell reselection procedure by using predetermined information. In the third embodiment, the predetermined information is information common to the first slice information and the second slice information and/or information common to the first frequency information and the second frequency information.

As described above, when the information included in the SIB16 is different from the information included in the RRC release message, the UE 100 performs the slice-specific cell reselection procedure using information common to the SIB16 and the RRC release message. Consequently, the UE 100 can appropriately execute the procedure.

### Operation Example According to Third Embodiment

An operation example according to the third embodiment will be described.

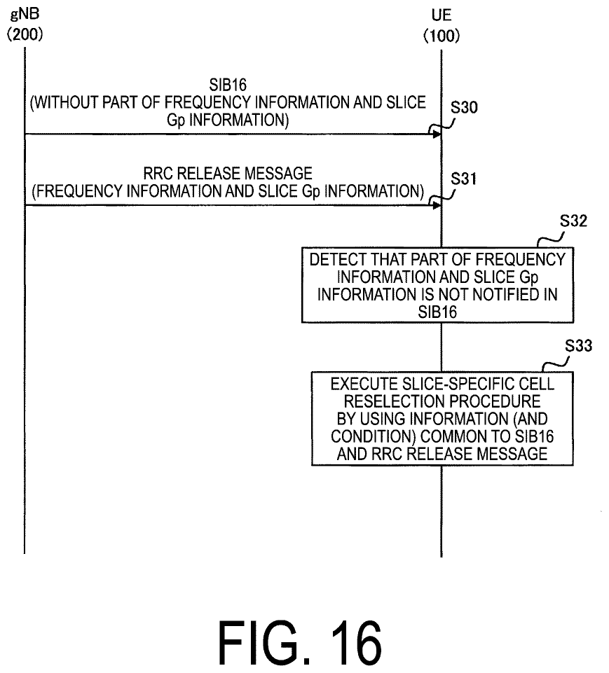

FIG. 16 is a diagram illustrating an operation example according to the third embodiment.

As illustrated in FIG. 16, in step S30, the gNB 200 broadcasts the SIB16. The SIB16 includes the frequency information and the slice group information. The UE 100 receives the SIB16.

In step S31, the gNB 200 transmits the RRC release message to the UE 100. The RRC release message includes the frequency information and the slice group information. However, in the third embodiment, similarly to the second embodiment, the SIB16 is assumed not to include a part of the frequency information and slice group information included in the RRC release message. After receiving the RRC release message, the UE 100 transitions to the RRC idle state or the RRC inactive state. Note that, by using the reception of the RRC release message as a trigger, the UE 100 starts the counting of the T320 timer included in the RRC release message.

In step S32, the UE 100 detects that the SIB16 does not include a part of the frequency information and slice group included in the RRC release message.

In step S33, the UE 100 applies the AND condition to the frequency information included in the SIB16 and the frequency information included in the RRC release message, and executes the slice-specific cell reselection procedure using information common to both pieces of frequency information. In step S33, the UE 100 applies the AND condition to the slice group information included in the SIB16 and the slice group information included in the RRC release message, and executes the slice-specific cell reselection procedure by using information common to both pieces of slice group information.

Note that the slice group information includes the frequency priority. When the frequency priority included in the SIB16 is different from the frequency priority included in the RRC release message, any one of the following methods may be adopted.

A1) The higher frequency priority is adopted.

A2) The lower frequency priority is adopted.

A3) The frequency priority of the RRC release message is adopted.

A4) The frequency priority of SIB16 is adopted.

A5) The gNB 200 indicates which frequency priority is adopted.

Note that A5) will be described in a fifth embodiment.

The UE 100 may perform the slice-specific cell reselection procedure by using information common to the SIB16 and the RRC release message until the T320 timer expires, and may perform the procedure by using the frequency information and slice group information included in the SIB16 after the T320 timer expires.

When not receiving the SIB16 even after the T320 timer expires (or when not receiving the SIB16 including the frequency information and the slice group information), the UE 100 may perform the slice-specific cell reselection procedure by using information common to the SIB16 and the RRC release message.

### Another Operation Example According to Third Embodiment

In the third embodiment, an example has been described in which the SIB16 does not include a part of the frequency information and the slice group included in the RRC release message, but the present invention is not limited to this.

First, in addition to the case where the SIB16 does not include a part of the frequency information included in the RRC release message, a case where the frequency information included in the SIB16 (for example, the first frequency information) is different from the frequency information included in the RRC release message (for example, the second frequency information) is present. Even in such a case, similarly to the second embodiment, the UE 100 may apply the AND condition to both pieces of frequency information and execute the slice-specific cell reselection procedure by using information common to both pieces of frequency information (step S33).

Second, in addition to the case where the SIB16 does not include a part of the slice group information included in the RRC release message, a case where the slice group information included in the SIB16 (for example, the first slice group information) is different from the slice group information included in the RRC release message (for example, the second slice group information) is present. Even in such a case, similarly to the third embodiment, the UE 100 may execute the slice-specific cell reselection procedure by using information common to both the SIB16 and the RRC release message (step S33).

Note that the slice support information may comply with the SIB16. The slice support information may be supported by all cells according to the Homogeneous principle.

### Fourth Embodiment

A fourth embodiment will be described. Also in the fourth embodiment, differences from the first embodiment will mainly be described.

In the fourth embodiment, an example will be described in which, when the information included in the SIB16 is different from the information included in the RRC release message, an OR condition is applied to both pieces of information, and the slice-specific cell reselection procedure is executed by using both pieces of information.

To be more specific, first, the base station (for example, the gNB 200) broadcasts the system information (for example, the SIB16). Second, the base station transmits the RRC release message to the user equipment (e.g., the UE 100). Third, when the first slice information included in the system information is different from the second slice information included in the RRC release message and/or when the first frequency information included in the system information is different from the second frequency information included in the RRC release message, the user equipment executes the slice-specific cell reselection procedure by using predetermined information. In the fourth embodiment, the predetermined information is the first slice information and the second slice information, and the first frequency information and the second frequency information.

As described above, when the information included in the SIB16 is different from the information included in the RRC release message, the UE 100 performs the slice-specific cell reselection procedure by using both pieces of information, and can thus appropriately perform the procedure.

### Operation Example According to Fourth Embodiment

An operation example according to the fourth embodiment will be described.

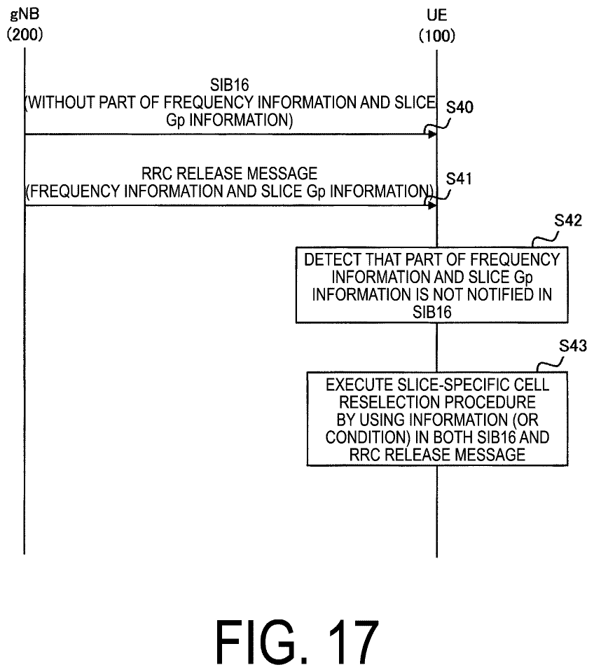

FIG. 17 is a diagram illustrating an operation example according to the fourth embodiment.

As illustrated in FIG. 17, in step S40, the gNB 200 broadcasts the SIB16. The SIB16 includes the frequency information and the slice group information. The UE 100 receives the SIB16.

In step S41, the gNB 200 transmits the RRC release message to the UE 100. The RRC release message includes the frequency information and the slice group information. However, in the fourth embodiment, similarly to the second embodiment, a part of the frequency information and slice group information included in the RRC release message is assumed not to be included in the frequency information and slice group included in the SIB16. After receiving the RRC release message, the UE 100 transitions to the RRC idle state or the RRC inactive state. Note that, by using the reception of the RRC release message as a trigger, the UE 100 starts the counting of the T320 timer included in the RRC release message.

In step S42, the UE 100 detects that the SIB16 does not include a part of the frequency information and slice group included in the RRC release message.

In step S43, the UE 100 applies the OR condition to the frequency information included in the SIB16 and the frequency information included in the RRC release message, and executes the slice-specific cell reselection procedure by using both pieces of frequency information. In step S43, the UE 100 applies the OR condition to the slice group information included in the SIB16 and the slice group information included in the RRC release message, and executes the slice-specific cell reselection procedure by using both pieces of slice group information.

Note that the slice group information includes the frequency priority. When the frequency priority included in the SIB16 is different from the frequency priority included in the RRC release message, any one of A1) to A5) described above may be adopted as in the third embodiment.

The UE 100 may perform the slice-specific cell reselection procedure by using the information common to the SIB16 and the RRC release message until the T320 timer expires, and may perform the procedure by using the frequency information and slice group information included in the SIB16 after the T320 timer expires.

When not receiving the SIB16 even after the T320 timer expires (or when not receiving the SIB16 including the frequency information and the slice group information), the UE 100 may perform the slice-specific cell reselection procedure by using the information in both the SIB16 and the RRC release message.

### Another Operation Example According to Fourth Embodiment

In the fourth embodiment, an example in which a part of the frequency information and the slice group included in the RRC release message is not included in the SIB16 has been described, but the present invention is not limited to this.

First, in addition to the case where the SIB16 does not include a part of the frequency information included in the RRC release message, a case where the frequency information included in the SIB16 (for example, the first frequency information) is different from the frequency information included in the RRC release message (for example, the second frequency information) is present. Even in such a case, similarly to the fourth embodiment, the UE 100 may apply the OR condition to both pieces of frequency information and execute the slice-specific cell reselection procedure by using both pieces of frequency information (step S43).

Second, in addition to the case where the SIB16 does not include a part of the slice group information included in the RRC release message, a case where the slice group information included in the SIB16 (for example, the first slice group information) is different from the slice group information included in the RRC release message (for example, the second slice group information) is present. Even in such a case, similarly to the fourth embodiment, the UE 100 may perform the slice-specific cell reselection procedure by using information common to both pieces of slice group information (step S43).

Note that the slice support information may comply with the SIB16. The slice support information may be supported by all cells according to the Homogeneous principle.

### Fifth Embodiment

A fifth embodiment will be described. In the fifth embodiment, differences from the first embodiment will mainly be described.

In the fifth embodiment, an example will be described in which when the information included in the SIB16 is different from the information included in the RRC release message, the gNB 200 notifies the UE 100 of instruction information indicating which information is to be complied with.

To be more specific, first, the base station (for example, the gNB 200) broadcasts the system information (for example, the SIB16). Second, the base station transmits the RRC release message to the user equipment (e.g., the UE 100). Third, when the first slice information included in the system information is different from the second slice information included in the RRC release message and/or when the first frequency information included in the system information is different from the second frequency information included in the RRC release message, the user equipment executes the slice-specific cell reselection procedure by using predetermined information. In the fifth embodiment, the base station further transmits, to the user equipment, instruction information indicating predetermined information. Second, the user equipment performs the slice-specific cell reselection procedure according to the instruction information.

As described above, when the information included in the SIB16 is different from the information included in the RRC release message, the UE 100 performs the slice-specific cell reselection procedure according to the instruction information from the gNB 200. Consequently, the UE 100 can appropriately execute the cell reselection procedure.

### Operation Example According to Fifth Embodiment

An operation example according to the fifth embodiment will be described.

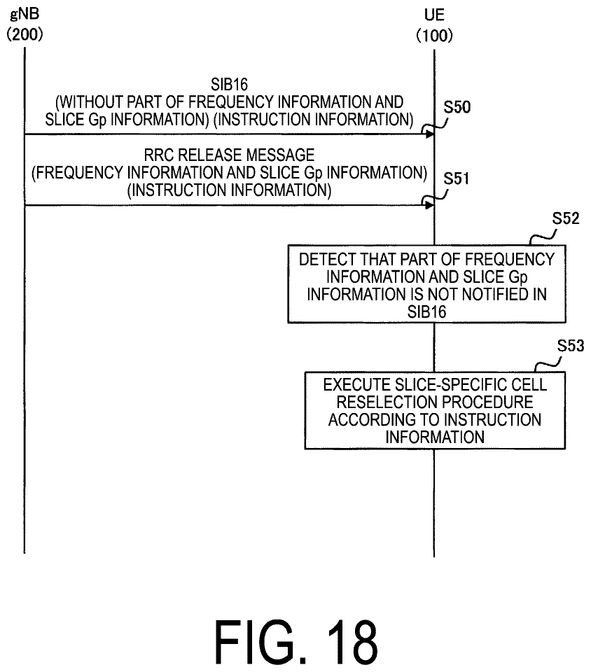

FIG. 18 is a diagram illustrating the operation example according to the fifth embodiment.

As illustrated in FIG. 18, the gNB 200 broadcasts the SIB16 in step S50. The SIB16 includes the frequency information and the slice group information. The UE 100 receives the SIB16. The gNB 200 may broadcast the SIB16 including the instruction information.

First, the instruction information includes instruction information for a case where the frequency information varies between the SIB16 and the RRC release message. The instruction information includes, for example, the following information.

B1) The frequency information included in the RRC release message is complied with.

B2) The frequency information included in the SIB16 is complied with.

B3) The AND condition is applied.

B4) The OR condition is applied.

B5) The slice-specific cell reselection procedure is not supported.

Second, the instruction information includes instruction information for a case where the slice group frequency information varies between the SIB16 and the RRC release message. The instruction information includes, for example, the following information.

C1) The higher priority is adopted.

C2) The lower priority is adopted.

C3) The slice group frequency information included in the RRC release message is adopted.

C4) The slice group frequency information included in the SIB16 is adopted.

Third, the instruction information includes instruction information for the slice support information. The instruction information includes, for example, the following information.

D1) According to the Homogeneous rule, a network slice notified in the RRC release message is supported by all cells.

D2) The presence or absence of network slice support of an NSAG present in the SIB16 depends on a slice allowed cell list (“sliceAllowedCellList”) or a slice excluded cell list (“sliceExcludedCellList”) included in the SIB16.

As described above, when the information included in the SIB16 (frequency information and/or slice group information) is different from the information included in the RRC release message (frequency information and/or slice group information), the instruction information is information indicating what kind of information is used as the predetermined information.

In step S51, the gNB 200 transmits the RRC release message to the UE 100. The RRC release message includes the frequency information and the slice group information. However, also in the fifth embodiment, similarly to the second embodiment, the frequency information and slice group included in the SIB16 do not include a part of the frequency information and slice group information included in the RRC release message. The gNB 200 may transmit the RRC release message including the instruction information. Specific information included in this instruction information may be the same as the instruction information included in the SIB16.

Note that, after receiving the RRC release message, the UE 100 transitions to the RRC idle state or the RRC inactive state. By using the reception of the RRC release message as a trigger, the UE 100 starts counting of the T320 timer included in the RRC release message.

In step S52, the UE 100 detects that the SIB16 does not include a part of the frequency information and slice group included in the RRC release message.

In step S53, the UE 100 executes the slice-specific cell reselection procedure according to the instruction information included in one of the SIB16 and the RRC release message.

Note that the UE 100 may perform the slice-specific cell reselection procedure according to the instruction information until the T320 timer expires, and may perform the procedure by using the frequency information and slice group information included in the SIB16 after the T320 timer expires.

Even after the T320 timer expires, when not receiving the SIB16 (or when not receiving the SIB16 including the frequency information and the slice group information), the UE 100 may perform the slice-specific cell reselection procedure according to the instruction information.

### Another Operation Example According to Fifth Embodiment

In the fifth embodiment, an example has been described in which the SIB16 does not include a part of the frequency information and slice group included in the RRC release message, but the present invention is not limited to this.

First, in addition to the case where the SIB16 does not include a part of the frequency information included in the RRC release message, a case where the frequency information included in the SIB16 (for example, the first frequency information) is different from the frequency information included in the RRC release message (for example, the second frequency information) is present. Even in such a case, similarly to the fourth embodiment, the UE 100 may execute the slice-specific cell reselection procedure according to the instruction information (step S53).

Second, in addition to the case where the SIB16 does not include a part of the slice group information included in the RRC release message, a case where the slice group information included in the SIB16 (for example, the first slice group information) is different from the slice group information included in the RRC release message (for example, the second slice group information) is present. Even in such a case, similarly to the fifth embodiment, the UE 100 may execute the slice-specific cell reselection procedure according to the instruction information (step S53).

### Other Embodiments

The gNB 200 may notify the UE 100 of the slice support information by using the RRC release message. In this case, for the difference between the SIB16 and the RRC release message, the method of the first embodiment, the second embodiment, the third embodiment, the fourth embodiment, or the fifth embodiment is applicable. That is, when the slice support information included in the SIB16 is different from the slice support information included in the RRC release message, the UE 100 may use the slice support information included in the RRC release message (first embodiment). The UE 100 may use the slice support information included in the SIB16 (second embodiment). The UE 100 may comply with the AND condition (third embodiment), may comply with the OR condition (fourth embodiment), or may be instructed by the gNB 200 using the instruction information (fifth embodiment).

When the slice support information can be notified in the RRC release message, the method of the first embodiment, the second embodiment, the third embodiment, the fourth embodiment, or the fifth embodiment is also applicable for the slice information including the slice support information and the slice group information. That is, when the slice information (for example, the first slice information) included in the SIB16 is different from the slice information (for example, the second slice information) included in the RRC release message, the UE 100 may use the slice information included in the RRC release message (the first embodiment). The UE 100 may use the slice information included in the SIB16 (second embodiment). The UE 100 may comply with the AND condition (third embodiment), may comply with the OR condition (fourth embodiment), or may be instructed by the gNB 200 using the instruction information (fifth embodiment).

In the first embodiment, an example has been described in which the gNB 200 configures the UE 100 with the number of timeouts and a new timer. The example in which the gNB 200 configures the UE 100 with the number of timeouts and a new timer is also applicable to the third embodiment, the fourth embodiment, and the fifth embodiment.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

Although the term “network node” mainly refers to a base station, it may also refer to an apparatus of a core network or a part (CU, DU or RU) of a base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

A program (information processing program) may be provided that causes a computer to execute each of the processing operations or each of the functions according to the embodiments described above. A program (for example, mobile communication program) may be provided that causes the mobile communication system 1 to execute each of the processing operations or each of the functions according to the embodiments described above. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. The embodiments, operation examples, processing operations, or the like may be combined without being inconsistent.

### First Appendix

### Supplementary Note 1

A communication control method in a mobile communication system, the communication control method including:
broadcasting, by a network apparatus, system information;
transmitting, by the network apparatus, an RRC release message to a user equipment; and executing, by the user equipment, a slice-specific cell reselection procedure by using predetermined information when first slice information included in the system information is different from second slice information included in the RRC release message and/or when first frequency information included in the system information is different from second frequency information included in the RRC release message.

### Supplementary Note 2

The communication control method according to Supplementary Note 1, wherein the predetermined information is the second slice information and/or the second frequency information.

### Supplementary Note 3

The communication control method according to Supplementary Note 1 or Supplementary Note 2, wherein the executing includes executing, by the user equipment, the slice-specific cell reselection procedure by using the second slice information and the second frequency information until the user equipment receives the system information even when a T320 timer expires.

### Supplementary Note 4

The communication control method according to any one of Supplementary Notes 1 to 3, wherein
the predetermined information is the first slice information and/or the first frequency information.

### Supplementary Note 5

The communication control method according to any one of Supplementary Notes 1 to 4, wherein
the predetermined information is information common to the first slice information and the second slice information, and information common to the first frequency information and the second frequency information.

### Supplementary Note 6

The communication control method according to any one of Supplementary Notes 1 to 5, wherein
the predetermined information is the first slice information, the second slice information, the first frequency information, and the second frequency information.

### Supplementary Note 7

The communication control method according to any one of Supplementary Notes 1 to 6, including:
transmitting, by the network node to the user equipment, instruction information indicating the predetermined information, wherein
the executing includes executing, by the user equipment, the slice-specific cell reselection procedure according to the instruction information.

### Second Appendix

### Introduction

The RAN2 #119e described below discussed the operation performed when the SIB16 and dedicated signaling are different from each other in information for slice-specific cell reselection, but the conclusion has been deferred.

5: P1, P2, and P3 in R2-2208519 were postponed. Is it possible to argue whether an implementation of the gNB always provides, in the SIB16, dedicated slice information only for frequencies/NSAG? If not, what should the applicable operation of the UE be? R2-2208519

Proposal 1: When the SIB16 is not broadcast in spite of availability of dedicated slice information, the UE does not perform slice-based cell reselection based on slices.

Proposal 2: When a frequency is present in the received FreqPriorityListDedicatedSlicing and no frequency is present in FreqPriorityListSling in the SIB16, the UE considers that none of the (prioritized) NSAGs can be used on this frequency.

Proposal 3: When nsag-id in FreqPriorityListDedicatedSlicing is not present in FreqPriorityListSlicing in the SIB16, the UE considers that the (prioritized) NSAGs are not supported on the frequency.

In this appendix, discussions will be made on the operation performed when the SIB16 and the dedicated signaling (hereinafter referred to as RRC release) are different from each other in information for slice-specific cell reselection, and an effect on specifications.

### Discussion

### Difference In IEs Between SIB16 and RRC Release

Information elements for slice-specific cell reselection in TS38. 331 are extracted as illustrated in FIGS. 12 and 13.

IEs that are available/unavailable between the SIB16 and the RRC release are summarized as follows.

TABLE 1

| INFORMATION ELEMENT | SIB 16 | RRC RELEASE |
|---|---|---|
| DL CARRIER FREQUENCY (dl-ImplicitCarrierFreq, dl- | A | A |
| ExplicitCarrierfreq) | | |
| nsag-IdentityInfo | A | A |
| NSAG CELL RESELECTION PRIORITY (nsag- | A | A |
| CellReselectionPriority, nsag-CellReselectionSubpriority) | | |
| | A | A |
| sliceCellListNR-r17 (SliceAllowedCellList, | A | N/A |
| SliceExcludedCellList) | | |

IEs for slice-specific cell reselection are available between the SIB16 and the RRC release. sliceCellList is available in the SIB16 but not in the RRC release according to Table 1.

Observation 1: The difference in availability between the SIB16 and the RRC release corresponds to sliceCellListNR. That is, the SIB16 includes sliceCellListNR but not the RRC release.

The other information elements between the SIB16 and the RRC release nsag-CellReslectionPriority and nsag-CellRelsectionSubPriority, have already been defined as follows.

### 5.2.4 Cell Reselection Evaluation Process

### 5.2.4.1 Reselection Priorities

When any fields with cellReselectionPriority or nsag-CellReselectionPriority are provided in dedicated signaling, the UE shall ignore any fields with cellReselectionPriority and nsag-CellReselectionPriority provided in the system information.

Between the SIB16 and the RRC release, a DL carrier frequency may have different values, and nsag-IdentityInfo has the same value. However, these IEs are taken into account without any change under the effect of nsag-CellReselectionPriority as follows.

### Example 1

| | |
|---|---|
| SIB16 INFORMATION | RRC RELEASE INFORMATION |
| Freq: A, nsag: 1, nsag- | Freq: A, nsag: 1, nsag- |
| CellReselectionPriority: 7 | CellReselectionPriority: 1 |
| Freq: B, nsag: 2, nsag- | |
| CellReselectionPriority: 5 | |

↓
UE, UNDER STUDY
Freq: A, nsag: 1, nsag-CellReselectionPriority: 1
Freq: B, nsag: 2, nsag-CellReselectionPriority: (ignored)

### Example 2

| | |
|---|---|
| SIB 16 INFORMATION | RRC RELEASE INFORMATION |
| Freq: A, nsag: 1, nsag- | Freq: C, nsag: 3, nsag- |
| CellReselectionPriority: 7 | CellReselectionPriority: 3 |
| Freq: B, nsag: 2, nsag- | |
| CellReselectionPriority: 5 | |

↓
UE, UNDER STUDY
Freq: A, nsag: 1, nsag-CellReselectionPriority: (ignored)
Freq: B, nsag: 2, nsag-CellReselectionPriority: (ignored)
Freq: C, nsag: 3, nsag-CellReselectionPriority: 3

Of course, when the SIB16 and the RRC release are different from each other, for nsag-CellRelesectionPriority and nsag-CellReselectionSubPrioritythe, the UE shall use nsag-CellRelesectionPriority and nsag-CellReselectionSubPriority configured in the RRC release without any change.

Observations and proposals as described below are provided.

Observation 1: For the DL carrier frequency, nsag-IdenityInfo, nsag-CellReslectionPriority, and nsag-CellRelsectionSubPriority, when the values are different between SIB16 and RRC release, the UE needs to use these values configured in the RRC release.

Therefore, all we need to do is to discuss the operation of sliceCellListNR.

Initially, the principle of slice homogeneous deployment may be applied. In Rel-17, RAN2 is consistent with the principle of homogeneity based on the following agreement. However, based on TR38. 832, slices may not be supported even by applying the homogeneous principle.

### Agreement (RAN2 #113-bis-e)

1: RAN2 is consistent with the SA2 assumption that the slice support within a TA is also homogeneous in Rel-17 (i.e., all cells within the TA support the availability of the same slices). When SA2 determines to support heterogeneous deployment, RAN2 can review this. TS38. 832

Problem 4: When failing to support a requested slice, the serving cell may need to execute a handover to a cell supporting the requested slice or to release an RRC connection”.

Therefore, it may not be reasonable that all slices configured in the RRC release are supported, and it is difficult to unconditionally consider all slices configured in the RRC release to be supported in all cells.

When the SIB16 includes sliceCellListNR, this IE has a universal value when the UE is configured with slice information in the RRC release. Therefore, when SliceCellListNR is not available in the RRC release, the UE needs to check the SIB16.

The SIB16 may not have been broadcast (the SIB1 includes no SIB16 scheduling information). In this case, the slice is considered to be supported in all cells. If the slice is partially supported by a cell or is supported in no cells, the only thing to be done by the gNB is to broadcast the SIB16 or the gNB need not include slice information in the RRC release (i.e. the UE is considered an implementation of such a gNB).

Proposal 2: When slice information is configured in the RRC release, the UE should consider that sliceCellListNR is implicitly the same as that in the SIB16 regardless of whether the SIB16 is broadcast.

For the effect on the specifications, when the SIB16 is broadcast, the current specifications are sufficient without the wording “the UE shall ignore a field with sliceCellListNR provided in the system information” in TS38. 304. When the SIB16 is not broadcast, the operation is the same as that performed when the SIB16 without sliceCellListNR is received.

Finally, in this appendix, discussions have been made on the operation performed when the IEs (i.e., DL carrier frequencies, nsag-IdentityInfo, NSAG Cell reselection priority, sliceCellListNR) have different values between the SIB16 and the RRC release. However, no particular problem is found, and thus the current specifications need not be changed.

Proposal 3: For a situation where the SIB16 and the dedicated signaling are different from each other in information for slice-specific cell reselection, the specifications need not be changed.

Whether the RRC release includes only frequency/NSAG slice information of the SIB16. A possible difference in slice-specific cell reselection information between the SIB16 and the RRC release should be consistent with a legacy operation where the information may be different between the SIB16 and the RRC release. No problems with this difference have been found.

Therefore, the principle of the relationship between the slice-specific cell reselection information and both SIB16 and RRC release should also be independent.

Proposal 4: The relationship between the slice-specific cell reselection information and both SIB16 and RRC release should be independent. That is, the information provided in the RRC release may be different from the information provided in the SIB16.

1. A communication control method comprising:
receiving, by a user equipment, an RRC release message from a network;
receiving, by the user equipment, system information used for a slice-specific cell reselection procedure from the network; and
executing, by the user equipment, the slice-specific cell reselection procedure by using only the RRC release message among the system information and the RRC release message, when information indicating a correspondence relationship between a slice group and a frequency is comprised in the RRC release message.

2. A communication control method comprising:
receiving, by a user equipment, an RRC release message from a network;
receiving, by the user equipment, system information used for a slice-specific cell reselection procedure from the network; and
executing, by the user equipment, the slice-specific cell reselection procedure by using only first frequency information among the first frequency information comprised in the RRC release message and second frequency information comprised in the system information, when the first frequency information is different from the second frequency information.

3. A communication control method comprising:
receiving, by a user equipment, an RRC release message from a network;
receiving, by the user equipment from the network, system information used for a slice-specific cell reselection procedure; and
executing, by the user equipment, the slice-specific cell reselection procedure by using only the RRC release message when the RRC release message comprises information indicating a correspondence relationship between a slice group and a frequency.

4. The communication control method according to claim 3, wherein the predetermined information is the second slice information and/or the second frequency information.

5. The communication control method according to claim 4, wherein the executing comprises executing, by the user equipment, the slice-specific cell reselection procedure by using the second slice information and/or the second frequency information even when a T320 timer expires.

6. The communication control method according to claim 3, wherein the predetermined information is the first slice information and/or the first frequency information.

7. The communication control method according to claim 3, wherein the predetermined information is information common to the first slice information and the second slice information, and information common to the first frequency information and the second frequency information.

8. The communication control method according to claim 3, wherein the predetermined information is the first slice information and the second slice information, and the first frequency information and the second frequency information.

9. The communication control method according to claim 3, comprising:
transmitting, by the network apparatus to the user equipment, instruction information indicating the predetermined information, wherein
the executing comprises executing, by the user equipment, the slice-specific cell reselection procedure according to the instruction information.

10. A user equipment comprising:
a receiver that receives an RRC release message and system information to be used for a slice-specific cell reselection procedure from a network apparatus; and
a controller that executes the slice-specific cell reselection procedure by using only the RRC release message among the system information and the RRC release message when information indicating a correspondence relationship between a slice group and a frequency is included in the RRC release message.
